(19) United States
(12) Patent Application Publication
(10) Pub. No.: US 2006/0036653 A1
(43) Pub. Date: Feb. 16, 2006

(54) Controller device to be connected to hard disk recorder via IEEE 1394 serial bus

(75) Inventor: Jyunya Senoo, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/203,098

(22) Filed: Aug. 15, 2005

(30) Foreign Application Priority Data
Aug. 16, 2004 (JP) 2004-236833

(51) Int. Cl. G06F 17/30

(52) U.S. Cl. 707/200

(57) ABSTRACT

When a user selects a program file using a remote controller and enters a command to delete all together program files with the same program title as the selected program file using the remote controller, a microprocessor in a set-top box (controller device) repeats searching for a program file with the same program title as the selected program file and sending a control command to delete a program file found as a result of the searching to an AVHDD (hard disk recorder) in which the found program file is stored until no more program files with the same program title as the selected program file are found. Accordingly, the set-top box can eliminate the need for a user to select individually all of program files with the same program title before deletion when all of the program files with the same program title are to be deleted.

### BACKGROUND OF THE INVENTION

1. Field of the Invention

The present invention relates to a controller device such as a set-top box, a digital television receiver, or the like that is connectable to a hard disk recorder such as a so-called audio/video hard disk drive (AVHDD) or the like via an IEEE 1394 serial bus.

2. Description of the Related Art

Hard disk recorders such as AVHDDs are increasingly used that can be connected to a controller device such as a set-top box or a digital television receiver via an IEEE 1394 serial bus cable to record or reproduce data in response only to a control command conforming to the IEEE 1394 standard. When deleting a program file recorded by such a hard disk recorder, a user generally adopts a method of selecting and deleting unwanted program files one by one on the controller device side or a method of selecting one by one unwanted program files to be deleted and then deleting the selected program files all together by one operation on the controller device side.

However, the above described methods may make the deletion of program files cumbersome and thus require much time to make the deletion. Especially in the case where a lot of program files with the same program title, e.g. program files of drama series, are present among program files stored in the hard disk recorder, the probability is high that if one of the program files is unwanted, the other program files with the same program title are also unwanted. Nevertheless, a user is required to select individually all of the unwanted program files with the same program title to delete them on the controller device side. In other words, the conventional controller device has a problem that it is inconvenient for a user to delete program files with the same program title that are stored in the hard disk recorder by using the controller device. This inconvenience is significant when there is a plurality of hard disk recorders connected to the controller device via an IEEE 1394 serial bus (hereinafter, referred to simply as “bus”). This is because, when a plurality of hard disk recorders are connected to the conventional controller device via the bus and a user desires to delete all of program files with the same program title stored in the plurality of hard disk recorders, it is necessary for the user to perform a search for a hard disk recorder that contains each of the program files with the same program title before delete operation for the program files.

### SUMMARY OF THE INVENTION

An object of the present invention is to provide a controller device to be connected to an IEEE 1394 serial bus that can eliminate the need for a user to select one by one all of program files with the same program title before deletion when all the program files with the same program title are to be deleted, thereby facilitating program file deletion.

According to a first aspect of the present invention, we provide a controller device to be connected via an IEEE 1394 serial bus to a hard disk recorder capable of sending and receiving a control command conforming to the IEEE 1394 standard, the controller device comprising: an IEEE 1394 interface for sending and receiving a control command conforming to the IEEE 1394 standard, a reply to the control command, and stream data between the controller device and the hard disk recorder; list creating means for creating a list of program files stored in the hard disk recorder; display means for displaying the list created by the list creating means; selection means for selecting a program file among the program files in the list displayed on the display means; delete-all command input means for entering a command to delete all together program files with the same program title as the program file selected by a user through the use of the selection means; search means for searching for a program file with the same program title as the user-selected program file among the program files stored in the hard disk recorder; delete means for deleting the program file found as a result of the searching by the search means; and delete-all operation control means for, when a user selects a program file using the selection means and enters the command to delete all together program files with the same program title as the selected program file using the delete-all command input means, repeating the searching by the search means and the deleting by the delete means until no more program files with the same program title as the program file selected using the selection means are found as a result of the searching by the search means.

With this configuration, as distinct from the conventional device, the controller device does not require a user to select individually all of program files with the same program title before deletion when all of the program files with the same program title are to be deleted, thereby facilitating the deletion of the program files. Especially when there is a plurality of hard disk recorders connected via the IEEE 1394 serial bus, the conventional controller device requires a user to perform a search for a hard disk recorder that contains each of program files with the same program title before deletion of the program files. On the other hand, the controller device according to the above aspect of the present invention requires a user to select only a program file among program files in the list that is displayed on the display means for showing the program files stored in all hard disk recorders connected thereto so that all of program files with the same program title as the selected program file are automatically deleted. This can greatly enhance ease of operation to delete all of program files with the same program title.

Preferably, two or more hard disk recorders are connected to the controller device via the IEEE 1394 serial bus.

According to a second aspect of the present invention, we provide a controller device to be connected via an IEEE 1394 serial bus to a hard disk recorder capable of sending and receiving a control command conforming to the IEEE 1394 standard, the controller device comprising: an IEEE 1394 interface for sending and receiving a control command conforming to the IEEE 1394 standard, a reply to the control command, and stream data between the controller device and the hard disk recorder; list creating means for creating a list of program files stored in the hard disk recorder; display means for displaying the list created by the list creating means; selection means for selecting a program file among the program files in the list displayed on the display means; delete-all command input means for entering a command to delete all together program files with the same program title as the program file selected by a user through the use of the selection means; search means for searching for a program file with the same program title as the user-selected program file among the program files stored in the hard disk recorder; and delete-all operation control means for controlling a delete-all operation to delete all of the program files with the same program title as the user-selected program file.

When a user selects a program file using the selection means and enters the command to delete all together program files with the same program title as the selected program file using the delete-all command input means, the delete-all operation control means carries out: sending, by the IEEE 1394 interface, a control command to delete the program file selected using the selection means to the hard disk recorder in which the selected program file is stored; and repeating the searching by the search means and sending of a control command to delete a program file found as a result of the searching to the hard disk recorder in which the found program file is stored until no more program files with the same program title as the program file selected using the selection means are found as a result of the searching by the search means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a perspective view of a set-top box according to one embodiment of the present invention and AVHDDs connected thereto;

FIG. 2 is an electrical block diagram of the set-top box and the AVHDD;

FIG. 3A shows a program file list before the set-top box executes a same-title delete process;

FIG. 3B shows the program file list after the set-top box executes the same-title delete process;

FIG. 4 shows a menu for a user to select an operation to be performed for a program file selected from the program file list; and

FIG. 5 is a flowchart showing the same-title delete process executed by the set-top box.

### DESCRIPTION OF THE PREFERRED EMBODIMENTS

Referring now to the accompanying drawings, the preferred embodiment of the present invention is described. The present invention relates to a controller device to be connected to a hard disk recorder via an IEEE 1394 serial bus. In the embodiment described below, the present invention is applied to a set-top box. It is to be noted that the following description of preferred embodiment of the present invention has been presented for purposes of illustration and description, and is not intended to be exhaustive or to limit the present invention to the precise form disclosed.

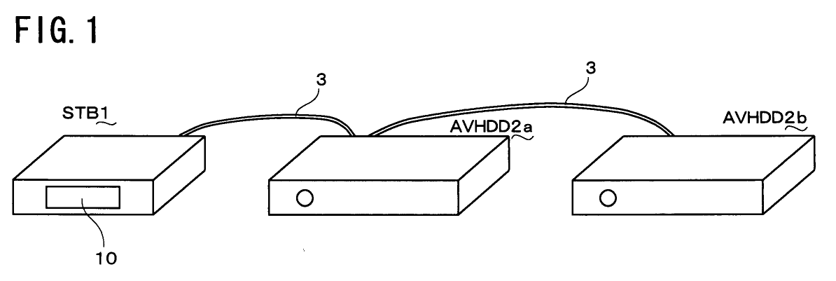

FIG. 1 shows an external view of a set-top box (claimed controller device) according to this embodiment and two AVHDDs (claimed hard disc recorder) connected to the set-top box. The set-top box (hereinafter, referred to as “STB”) 1 is a device that outputs a broadcast signal on a user-selected channel among received broadcast signals. The AVHDD 2a or 2b is a hard disk recorder of a type that is capable of recording or reproducing data in response only to a control command conforming to the IEEE 1394 standard. As shown in FIG. 1, disposed at the front of the STB 1 is a display 10 (display means) for displaying a list of program files stored in the AVHDDs 2a and 2b, various menus, and so on. The STB 1 and the AVHDD 2a, and the AVHDD 2a and the AVHDD 2b are connected by IEEE 1394 serial bus cables 3. More particularly, the STB 1 and the AVHDDs 2a and 2b are daisy-chained. In this embodiment, the AVHDDs 2a and 2b can perform operations such as, for example, recording, reproduction, and deletion in response only to control commands conforming to the IEEE 1394 standard that is sent from the STB 1.

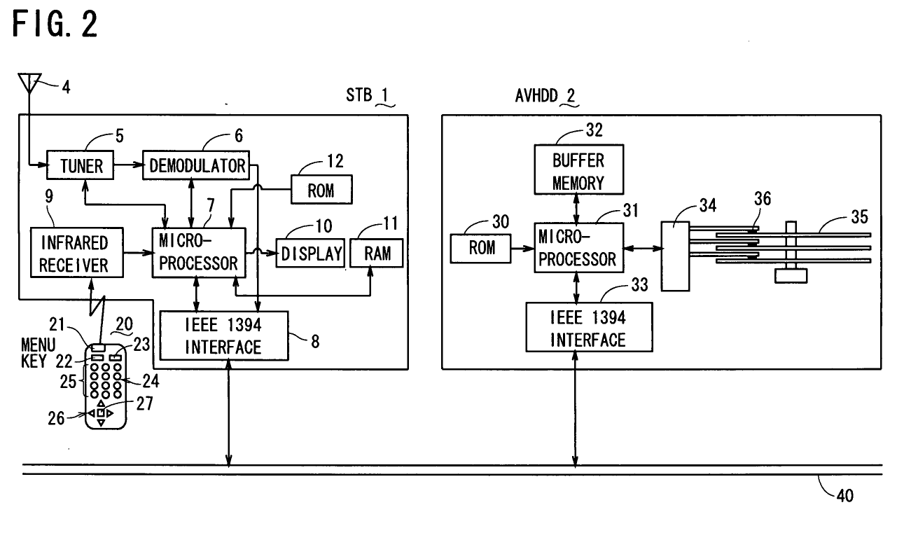

Referring now to FIG. 2, the electrical configuration of the STB 1 and the AVHDDs 2a and 2b is described. In FIG. 2, the AVHDDs 2a and 2b are shown collectively as the AVHDD 2. The STB 1 comprises a microprocessor 7 (claimed delete-all operation control means, list creating means, search means, and delete means) that controls each component in the device. The microprocessor 7 is connected to the display 10, a tuner 5, a demodulator 6, an IEEE 1394 interface 8 (hereinafter referred to simply as “interface”), an infrared receiver 9, a RAM 11, and a ROM 12.

The tuner 5 extracts a broadcast signal on a user-selected channel from broadcast signals received through an antenna 4. The demodulator 6 demodulates the broadcast signal extracted by the tuner 5 in accordance with the broadcasting method. The interface 8 is an interface circuit for sending and receiving data between the STB and other devices on an IEEE 1394 serial bus (hereinafter referred to simply as “bus”) 40. The interface 8 sends and receives data to and from the AVHDD 2 via the bus 40. The infrared receiver 9 receives an infrared command signal transmitted from a remote controller 20 and converts the command signal into a standard digital signal for output to the microprocessor 7. The RAM 11 temporarily stores data such as a program file list described below. The ROM 12 stores various menus and control programs.

The remote controller 20 (selection means and delete-all command input means) has an infrared transmitter 21 and a key portion 24, where arranged are various keys such as a power key 23, numeric keys 25, cursor keys 26, an enter key 27, and a menu key 22 for causing various menus to be displayed. The keys on the remote controller 20 are used, for example, to select a program file among program files in a list displayed on the display 10 or to enter a command to delete all together program files with the same program title as the selected program file.

The AVHDD 2 comprises a microprocessor 31 for controlling each component therein, a ROM 30 for storing a control program for the microprocessor 31, an IEEE 1394 interface (hereinafter referred to simply as “interface”) 33 for sending and receiving, via the bus 40, data such as a control command and stream data between the AVHDD 2 and the STB 1 or other devices. The AVHDD 2 further comprises a plurality of hard disks 35 on which data is recorded, a plurality of magnetic heads 36 for recording and reading data on and from the hard disks 35, a head drive unit 34 for driving the magnetic heads 36, and a buffer memory 32 for temporarily storing data to be recorded or data read.

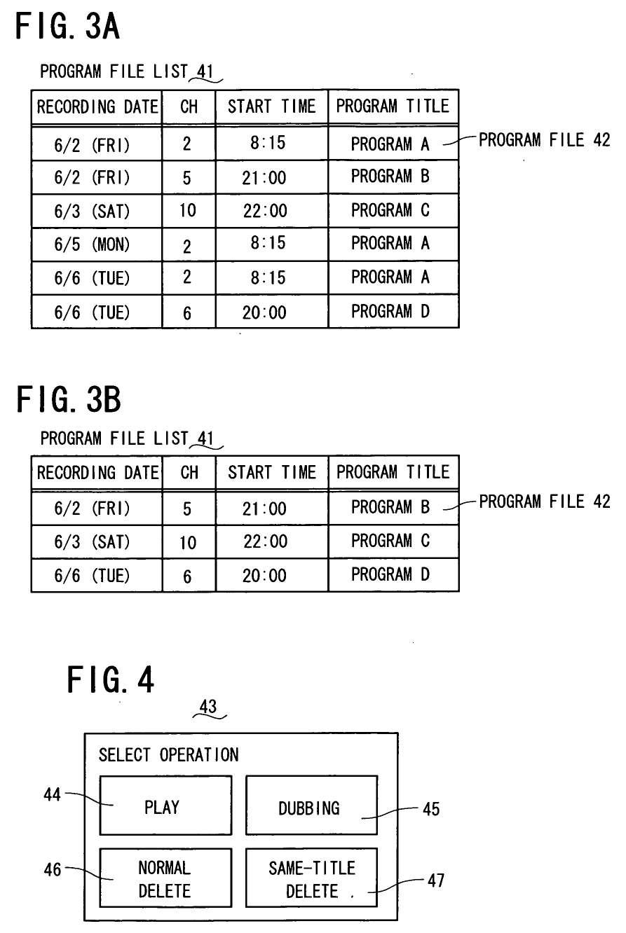

Referring now to FIGS. 3A, 3B, and 4, description is made as to an operation to be performed by a user when deleting all program files with the same program title (hereinafter, referred to as “same-title deleting operation”). This same-title deleting operation includes selecting a program file among program files in a list displayed on the display 10 and entering a command to delete all together program files with the same program title as the selected program file. When a user enters a command to display a list of program files stored in the AVHDDs 2a and 2b shown in FIG. 1 using the remote controller 20, the microprocessor 7 on the STB 1 side receives, via the bus 40, data such as the recording dates, the recording start times, and the program titles of the respective program files 42 stored in the AVHDDs 2a and 2b. Based on the received data, the microprocessor 7 creates a program file list 41 as shown in FIG. 3A and displays the created program file list 41 on the display 10. Then, a user selects a program file 42 among the program files 42 in the program file list 41 using the remote controller 20. In response to the selection, the microprocessor 7 displays a program file operation selection submenu 43 as shown in FIG. 4 to prompt a user to select an operation to be performed for the selected program file 42. When a user selects a same-title delete button 47 within the program file operation selection submenu 43 using the cursor key 26 and the enter key 27 on the remote controller 20, the microprocessor 7 executes a same-title delete process described in detail below to delete all of program files 42 with the same program title as the program file 42 selected in the above selection among the program files 42 in the program file list 41. For example, when a program file 42 of “Program A” is selected from the program file list 41 shown in FIG. 3A and then the same-title delete process is executed for “Program A”, all of program files 42 of which the program titles are “Program A” are deleted from the program file list 41, so that they are not included in the program file list 41 after execution of the same-title delete process as shown in FIG. 3B.

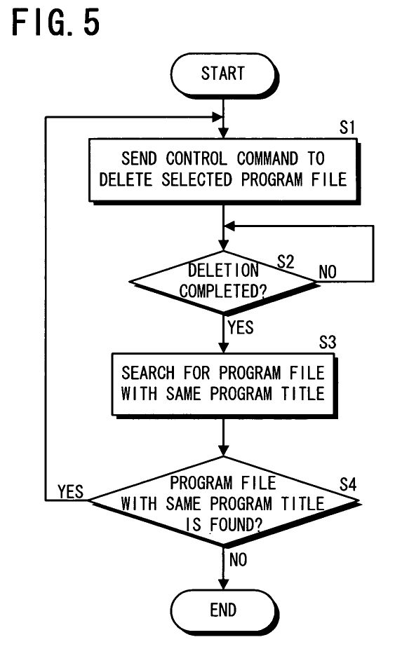

Referring now to the flowchart of FIG. 5, the same-title delete process is described. When a user performs the above described same-title deleting operation using the remote controller 20, the microprocessor 7 on the STB 1 side sends, by the interface 8, a control command to delete a program file 42 selected among the program files 42 in the above described program file list 41 to the AVHDD 2a or 2b in which the selected program file 42 is stored (S1) and waits for a response to the delete command from the AVHDD 2a or 2b. When the microprocessor 7 receives a response indicating that the deletion has been completed (YES at S2), it searches for a program file 42 with the same program title as the deleted program file 42 among the program files 42 stored in all the AVHDDs 2a and 2b (S3). When a program file with the same program title is found as a result of the searching (YES at S4), the microprocessor 7 repeats the process of the steps S1 to S3 to send a control command to delete the program file 42 found by the searching at the step S3 to the AVHDD 2a or 2b in which the found program file 42 is stored. The process of the steps S1 to S3 is repeated until no more program files with the same program title are found as a result of the searching at the step S3, i.e., until all of program files 42 with the same program title as the program file 42 selected among the program files 42 in the program file list 41 are deleted or removed from all the AVHDDs 2a and 2b.

As described above, when a user selects a program file 42 and enters a command to delete all together program files 42 with the same program title as the selected program file 42, the STB 1 according to this embodiment repeats searching for a program file 42 with the same program title among program files 42 stored in all the AVHDDs 2a and 2b and sending a control command to delete the program file 42 found as a result of the searching to the AVHDD 2a or 2b in which the found program file 42 is stored until no more program files 42 with the same program title are found. Accordingly, as distinct from a conventional STB, the STB 1 of this embodiment does not require a user to select individually all of program files 42 with the same program title before deletion when all of the program files 42 with the same program title are to be deleted, thereby facilitating the deletion of the program files 42. Especially when there is a plurality of AVHDDs 2 connected via the IEEE 1394 serial bus 40 as in this embodiment, the conventional STB requires a user to search for an AVHDD that stores each of program files with the same program title before deletion of the program files. On the other hand, the STB 1 according to this embodiment requires a user to select only a program file 42 among program files 42 in the list 41 that is displayed on the display 10 for showing the program files 42 stored in all AVHDDs connected thereto, the AVHDDs 2a and 2b in this embodiment so that all of program files 42 with the same program title as the selected program file 42 are automatically deleted. This can greatly enhance ease of operation to delete all of program files 42 with the same program title.

The present invention has been described above using a presently preferred embodiment, but those skilled in the art will appreciate that various modifications are possible. Accordingly, all such modifications are intended to be included within the spirit and scope of the present invention. For example, the present invention is applied to the STB 1 in the above embodiment, but it can be applied to another controller device such as a digital television receiver or the like. The hard disk recorder connected to the STB 1 via the IEEE 1394 serial bus 40 is not necessarily the AVHDD used in the above embodiment but can be a typical hard disk recorder for example. Further, in the above embodiment, two AVHDDs are connected to the STB 1 via the IEEE 1394 serial bus 40, but a single or more than two AVHDDs can be connected to the STB.

This application is based on Japanese patent. application 2004-236833 filed Aug. 16, 2004, the contents of which are hereby incorporated by reference.

What is claimed is:

1. A controller device to be connected via an IEEE 1394 serial bus to a hard disk recorder capable of sending and receiving a control command conforming to the IEEE 1394 standard, the controller device comprising:
an IEEE 1394 interface for sending and receiving a control command conforming to the IEEE 1394 standard, a reply to the control command, and stream data between the controller device and the hard disk recorder;
list creating means for creating a list of program files stored in the hard disk recorder;
display means for displaying the list created by the list creating means;
selection means for selecting a program file among the program files in the list displayed on the display means;
delete-all command input means for entering a command to delete all together program files with the same program title as the program file selected by a user through the use of the selection means;
search means for searching for a program file with the same program title as the user-selected program file among the program files stored in the hard disk recorder;
delete means for deleting the program file found as a result of the searching by the search means; and
delete-all operation control means for, when a user selects a program file using the selection means and enters the command to delete all together program files with the same program title as the selected program file using the delete-all command input means, repeating the searching by the search means and the deleting by the delete means until no more program files with the same program title as the program file selected using the selection means are found as a result of the searching by the search means.

2. The controller device according to claim 1, wherein two or more hard disk recorders are connected to the controller device via the IEEE 1394 serial bus.

3. The controller device according to claim 1, wherein the controller device is a set-top box.

4. The controller device according to claim 1, wherein the hard disk recorder connected to the controller device via the IEEE 1394 serial bus is an AVHDD that is a hard disk recorder capable of recording and reproducing data in response only to a control command conforming to the IEEE 1394 standard.

5. A controller device to be connected via an IEEE 1394 serial bus to a hard disk recorder capable of sending and receiving a control command conforming to the IEEE 1394 standard, the controller device comprising:
an IEEE 1394 interface for sending and receiving a control command conforming to the IEEE 1394 standard, a reply to the control command, and stream data between the controller device and the hard disk recorder;
list creating means for creating a list of program files stored in the hard disk recorder;
display means for displaying the list created by the list creating means;
selection means for selecting a program file among the program files in the list displayed on the display means;
delete-all command input means for entering a command to delete all together program files with the same program title as the program file selected by a user through the use of the selection means;
search means for searching for a program file with the same program title as the user-selected program file among the program files stored in the hard disk recorder; and
delete-all operation control means for controlling a delete-all operation to delete all of the program files with the same program title as the user-selected program file,
wherein, when a user selects a program file using the selection means and enters the command to delete all together program files with the same program title as the selected program file using the delete-all command input means, the delete-all operation control means carries out:
sending, by the IEEE 1394 interface, a control command to delete the program file selected using the selection means to the hard disk recorder in which the selected program file is stored; and
repeating the searching by the search means and sending of a control command to delete a program file found as a result of the searching to the hard disk recorder in which the found program file is stored until no more program files with the same program title as the program file selected using the selection means are found as a result of the searching by the search means.

6. The controller device according to claim 5, wherein two or more hard disk recorders are connected to the controller device via the IEEE 1394 serial bus.

7. The controller device according to claim 5, wherein the controller device is a set-top box.

8. The controller device according to claim 5, wherein the hard disk recorder connected to the controller device via the IEEE 1394 serial bus is an AVHDD that is a hard disk recorder capable of recording and reproducing data in response only to a control command conforming to the IEEE 1394 standard.
